(19) United States
(12) Patent Application Publication
(10) Pub. No.: US 2008/0192773 A1
(43) Pub. Date: Aug. 14, 2008

(54) METHODS AND APPARATUS TO MANAGE BANDWIDTH UTILIZATION IN AN ACCESS NETWORK

(76) Inventors: Canhui Ou, Danville, CA (US); John Van Slyke, Lafayette, CA (US); Stephen A. Sposato, Lafayette, CA (US); Russell B. Bellford, New Berlin, WI (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/674,520

(22) Filed: Feb. 13, 2007

(51) Int. Cl. H04J 3/16

(52) U.S. Cl. 370/468

(57) ABSTRACT

Methods and apparatus to manage bandwidth utilization in an access network are disclosed. A disclosed example apparatus comprises an access multiplexer communicatively coupled to a services network via a communication path, and configured to communicate with a first user device via a first connection and with a second user device via a second connection; and a bandwidth manager to set a first bandwidth profile for the first connection and a second bandwidth profile for the second connection based on a utilization of the communication path.

### FIELD OF THE DISCLOSURE

This disclosure relates generally to access networks and, more particularly, to methods and apparatus to manage bandwidth utilization in an access network.

### BACKGROUND

In the past, the utilization of access networks (e.g., digital subscriber line (DSL), wireless and/or cable modem access networks) has been relatively low due to low subscription rates. Such under utilized access networks can generally accommodate unforeseeable increases in traffic due to events, such as sharply increased telecommuting during a period of days or weeks in response to a pandemic outbreak and/or a storm. However, as subscription rates increase, the utilization and/or loading of a communication path (e.g., backhaul transmission link) transporting traffic between (a) an access multiplexer (e.g., a DSL access multiplexer (DSLAM), a wireless base station and/or a cable modem termination system (CMTS)) and (b) a service network (e.g., the AT&T Internet Services network) increases. When the utilization and/or loading of the communication path becomes high enough, customers accessing the service network via the access multiplexer associated with the backhaul transmission link may experience lower data rates, higher latencies and/or intermittent connections.

### BRIEF DESCRIPTION OF THE DRAWINGS

FIG. 1 is a diagram of an example communication system constructed in accordance with the teachings of the invention.

FIG. 2 illustrates an example manner of implementing any of the example bandwidth managers of FIG. 1.

FIG. 3 illustrates an example data structure that may be used to implement the example profiles of FIG. 2.

FIGS. 4 and 5 illustrate example data structures that may be used to implement the example customer records of FIG. 2.

FIG. 6 is a flowchart representative of example machine accessible instructions that may be executed to implement any of the example bandwidth managers of FIGS. 1 and/or 2.

FIG. 7 is a schematic illustration of an example processor platform that may be used and/or programmed to execute the example machine readable instructions represented by FIG. 6 to implement any of the example bandwidth managers described herein.

### DETAILED DESCRIPTION

Methods and apparatus to manage bandwidth utilization in an access network are disclosed. A disclosed example apparatus includes an access multiplexer communicatively coupled to a services network via a communication path, and configured to communicate with a first user device via a first connection and with a second user device via a second connection; and a bandwidth manager to set a first bandwidth profile for the first connection and a second bandwidth profile for the second connection based on a utilization of the communication path.

A disclosed example method of configuring an access network includes measuring a utilization of a communication path between an access multiplexer and a broadband remote access server (BRAS), the communication path transporting data for one or more connections between the access multiplexer and respective ones of one or more user devices; and setting a bandwidth profile for a first one of the one or more connections based on the measured utilization of the communication path.

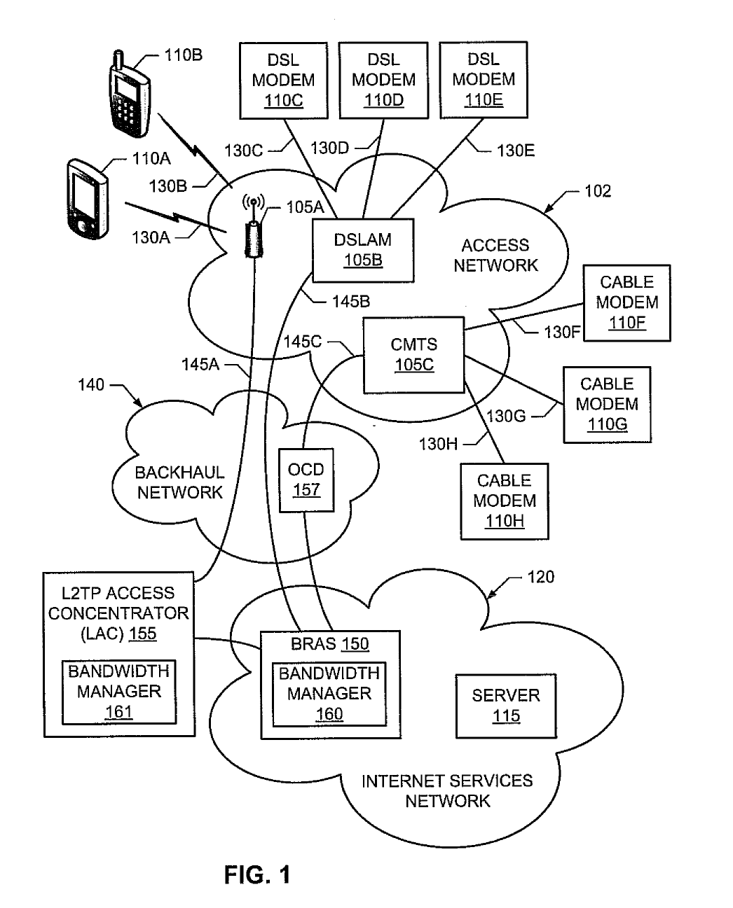

FIG. 1 is a schematic diagram of an example communication system constructed in accordance with the teachings of invention. To provide data and/or communication services (e.g., telephone services, Internet services, data services, messaging services, instant messaging services, electronic mail (email) services, chat services, video services, audio services, gaming services, etc.), the example communication system of FIG. 1 includes any number and/or type(s) of access networks, one of which is illustrated in FIG. 1 with reference numeral 102, and any number and/or type(s) of fixed-location, substantially fixed-location and/or mobile user devices (eight of which are respectively designated in FIG. 1 with reference numerals 110A-H).

To provide communicative coupling of the example user devices 110A-H to the example access network 102, the example access network 102 of FIG. 1 includes any number and/or type(s) of access multiplexers, three of which are respectively designated in FIG. 1 with reference numbers 105A, 105B and 105C. The example access multiplexers 105A-C of FIG. 1 may be implemented at and/or within, for example, a central office (CO), a pedestal, a remote terminal (RT) and/or a service provider's headend. The example access network 102, the example access multiplexers 105A-C and/or the example user devices 110A-H of FIG. 1 are implemented in accordance with one or more past, present and/or future wired (e.g., electrical, optical, etc.) and/or wireless communication protocol(s), standard(s) and/or specification(s) (e.g., one or more past, present and/or future standards from the Institute of Electrical and Electronics Engineers (IEEE) 802.x family of standards, the International Telecommunications Union (ITU) Telecommunication Standardization Sector (ITU-T)) and/or implement features from one or more of those protocols, standards and/or specifications.

The example access network 102 and/or the example access multiplexers 105A-C of FIG. 1 may be implemented by any number and/or type(s) of communication devices, cables, networks, technologies and/or systems. Example access networks include any type of public switched telephone network (PSTN) system(s), public land-mobile network (PLMN) system(s), wireless distribution system(s), wired or cable distribution system(s), coaxial cable distribution system(s), fiber-to-the-home network(s), fiber-to-the-curb network(s), fiber-to-the-pedestal network(s), fiber-to-the-vault network(s), fiber-to-the-neighborhood network(s), Ultra High Frequency (UHF)/Very High Frequency (VHF) radio frequency system(s), satellite or other extra-terrestrial system(s), cellular distribution system(s), power-line broadcast system(s), and/or combinations and/or hybrids of these devices, systems and/or networks. While in the illustrated example of FIG. 1, the user devices 110A-H are implemented separately from the access network 102, the example access network 102 may extend geographically to include locations near to and/or encompassing any or all of the user devices 110A-H.

Example access multiplexers include a wireless base station 105A (e.g., implemented in accordance with the IEEE 802.16x and/or IEEE 802.11x families of standards), a digital subscriber line (DSL) access multiplexer (DSLAM) 105B (e.g., implemented in accordance with the ITU-T G.992.x family of standards), and/or a cable modem termination system (CMTS) 105C (e.g., implemented in accordance with the ITU-T J.112 and/or J.122 standards). Example user devices include a personal digital assistant (PDA) 110A, an MP3 player such as an iPod®, a telephone 110B (e.g., a cellular phone, a voice over Internet Protocol (VoIP) phone, a smart phone, etc.), a laptop computer with wireless communication capabilities, etc. Example fixed-location or substantially fixed-location user devices include, for example, a desktop personal computer (PC) with wireless communication capabilities, DSL modems 110C-E, cable modems 110F-H, etc.

To allow the plurality of example user devices 110A-H of FIG. 1 to communicate with remote devices and/or servers (e.g., a server 115 of an example service network 120), each of the example user devices 110A-H is communicatively coupled via a respective connection 130A-H to one of the example access multiplexers 105A-C. For example, the example wireless devices 110A and 110B are communicatively coupled via respective wireless connections 130A and 130B to the example wireless base station 105A, the example DSL modems 110C-E are communicatively coupled via respective DSL connections 130C-E to the example DSLAM 105B, and the example cable modems 110F-H are communicatively coupled via respective cable modem connections 130F-H to the example CMTS 105C.

To transport data to and/or from the example access multiplexers 105A-C, the example communication system of FIG. 1 includes any number and/or type(s) of backhaul network (one of which is designated with reference numeral 140 in FIG. 1), and respective communication paths 145A-C through the backhaul network 140 for each access multiplexer 105A-C. The example backhaul network 140 and the example communication paths 135A-C of FIG. 1 communicatively couple the example access multiplexers 105A-C to any number and/or type(s) of access servers, such as a broadband remote access server (BRAS), one of which is shown with reference numeral 150 in FIG. 1.

The example communication paths 145A-C and/or the backhaul network 140 of FIG. 1 are implemented by any number and/or type(s) of past, current and/or future communication network(s), communication system(s), communication device(s), transmission medium(s), protocol(s), technique(s), specification(s) and/or standard(s). For example, the example access multiplexers 105A-C may be coupled to the BRAS 150 via any type(s) of Ethernet transceiver(s), optical transceiver(s) and/or ATM transceiver(s) implemented by and/or within the example access multiplexers 105A-C, the example communication paths 145A-C and/or the example backhaul network 140. In general, a particular communication path 145A-C has a limited bandwidth, transmission speed, and/or reception speed that may be used by a respective access multiplexer 105A-C to exchange data with the BRAS 150.

As illustrated in FIG. 1, the communication paths 145A-C may be direct and/or indirect communication paths between the access multiplexers 105A-C and the BRAS 150. For example, the example communication path 145A passes through any type of Layer 2 Tunnel Protocol (L2TP) access concentrator (LAC) 155. Similarly, the example communication path 145C passes through any type of optical coupling device (OCD) 157. Any of the example communication paths 145A-C may be implemented as one or more communicatively coupled segments. For example, a communication path 145A-C may include a first segment from a respective access multiplexer 105A-C to the backhaul network 140, a second segment through the backhaul network 140, and a third segment from the backhaul network 140 to the BRAS 150.

The example communication paths 145A-C of FIG. 1 carry and/or transport data for a plurality of user devices 110A-H. For example, the example communication path 145B transports data associated with the example DSL modems 110C-E that are communicatively coupled to the example DSLAM 105B. Thus, in the example communication system of FIG. 1, as the number of user devices 110A-H connected to and/or transmitting data to and/or from an access multiplexer 105A-C increases, and/or as the amount and/or speed of data transmitted by any of the user devices 110A-H increases, the loading and/or utilization of the communication path 145A-C associated with the access multiplexer 105A-C increases.

The example BRAS 150 of FIG. 1 controls and/or limits access of the user devices 110A-H to any number and/or type(s) of public and/or private service networks, such as the example Internet services network 120. For example, the BRAS 150 may verify the identity of a user and/or user device 110A-H before the user and/or user device 110A-H is allowed to access data and/or communication services implemented by and/or provided by the example service network 120.

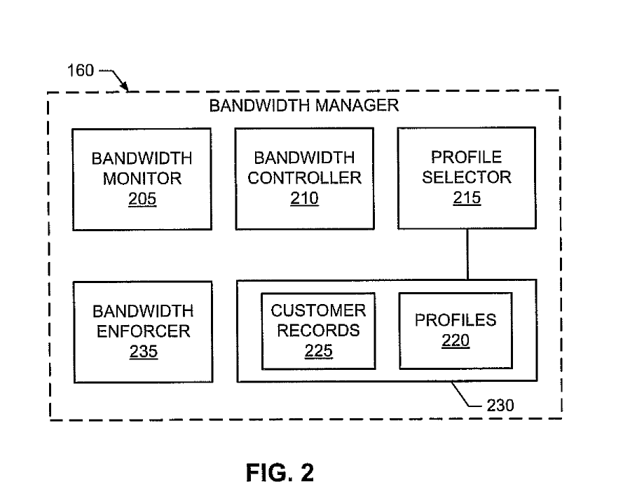

Because each of the example access multiplexers 105A-C of FIG. 1 is respectively coupled to the example BRAS 150 and/or the example LAC 155 via a communication path 145A-C, data associated with all of the user devices 110A-H of a particular access multiplexer 105A-C share the bandwidth of the corresponding communication path 145A-C. To control and/or configure the allocation of the shared bandwidth to the user devices 110A-H, the example access network of FIG. 1 includes one or more bandwidth managers, two of which are respectively illustrated in FIG. 1 with reference numerals 160 and 161. The example bandwidth managers 160 and 161 of FIG. 1 monitor the current utilization and/or loading of their corresponding communication paths 145A-C and/or any segment(s) of their corresponding communication paths 145A-C. Based on the current utilization and/or loading of a particular communication path 145A-C and/or segment(s) of the particular communication path 145A-C, a bandwidth manager 160, 161 selects, sets and/or enforces a bandwidth profile for each of the example connections 130A-H and/or the corresponding user devices 110A-H having data transported via the particular communication path 145A-C (i.e., users devices associated with that communication path 145A-C). Example manners of implementing any and/or all of the example bandwidth managers 160 and 161 of FIG. 1 are described below in connection with FIG. 2.

When the utilization of a particular communication path 145A-C and/or segment(s) of the particular communication path 145A-C exceeds a threshold (e.g., 80% or 90% utilization), the bandwidth manager 160, 161 selects, sets and/or enforces a relatively lower data rate bandwidth profile for one or more (e.g., all) of the user devices associated with the particular communication path 145A-C. Likewise, when the utilization falls below a second threshold (e.g., 50% or 60% utilization), the bandwidth manager 160, 161 selects, sets and/or enforces a relatively higher data rate bandwidth profile for one or more (e.g., all) of user devices associated with that communication path 145A-C. In the illustrated example of FIG. 1, as the loading of a communication path 145A-C changes, all user devices associated with that communication path 145A-C have their bandwidth profile adjusted. For example, as the loading of a given communication path 145A-C increases, all user devices of the given communication path 145A-C are changed to a relatively lower data rate bandwidth profile than a current profile, thereby, ensuring fair and/or equitable access to the bandwidth of the communication path 145A-C.

In the example communication system of FIG. 1, the bandwidth profiles are enforced at the example BRAS 150 and/or the example LAC 155. Thus, when a bandwidth profile having a relatively lower data rate than the current bandwidth profile is enforced for a particular user device 110A-H, the BRAS 150 and/or the LAC 155 cause a temporary increase in the round-trip transmission time between the particular user device 110A-H and the service network 120. Because the service network 120 and/or the user devices 110A-H each implement a media access control (MAC) function (e.g., as defined by the transmission control protocol (TCP)/IP MAC), the service network 120 and/or the user devices 110A-H will react to this increased transmission time by transmitting data at a lower data rate, thereby, reducing the loading and/or utilization of the communication path 145A-C transporting the data for the user device 110A-H.

Each of the user devices 110A-H can have potentially different active bandwidth profiles. In particular, a bandwidth profile for a particular user device 110A-H is selected from a set of bandwidth profiles determined based on a service agreement in effect for the user device 110A-H. Example service agreement levels are 6 Million bits per second (Mbps), 3 Mbps, 1.5 Mbps, 768 kilo bits per second (kbps) and 384 kbps. For example, a first user device 110A-H may be associated with a 3 Mbps service agreement that specifies a minimum data rate of 1.5 Mbps and a maximum data rate of 3 Mbps, while a second user device 110A-H may be associated with a 6 Mbps service agreement having a minimum of 3 Mbps and a maximum of 6 Mbps. Thus, the example bandwidth manager 160, 161 selects a bandwidth profile for a user device 110A-H from a set of bandwidth profiles that satisfy their respective service agreement. The example bandwidth managers 160, 161 of FIG. 1 do not select a bandwidth profile that falls outside of the range of bandwidth profiles corresponding to a user devices' service agreement. However, persons of ordinary skill in the art will readily appreciate that in some alternative implementations a bandwidth manager could select a bandwidth profile falling outside of a service agreement (e.g., falling below the minimum data rate) even though such a selection may violate the terms of the service agreement.

The example communication system of FIG. 1 is structured to have a sufficient number of bandwidth profiles (e.g., three) per service agreement. For example: bandwidth profiles of 6 Mbps, 4 Mbps and 3 Mbps for a 6 Mbps service agreement; bandwidth profiles of 3 Mbps, 2 Mbps and 1.5 Mbps for a 3 Mbps service agreement; bandwidth profiles of 1.5 Mbps, 1 Mbps and 768 kbps for a 1.5 Mbps service agreement; bandwidth profiles of 768 kbps, 512 kbps and 384 kbps for a 768 kbps service agreement; and bandwidth profiles of 384 kbps, 256 kbps and 192 kbps for a 384 kbps service agreement. However, any number of bandwidth profiles per service agreement could be used. In general, as the number of bandwidth profiles per service agreement is increased, the utilization of the communication paths 145A-C can be controlled more precisely while maximizing the data rate available to each user device 110A-H.

In the illustrated example communication system of FIG. 1, the example access network 102, the example access multiplexers 105A-C, the example backhaul network 140, the example communication paths 145A-C, the example BRAS 150 and the example LAC 155 are owned and/or operated by a single service provider. That is, the service provider owns, operates, utilizes, implements and/or configures the access network 102, the access multiplexers 105A-C, the backhaul network 140, the communication paths 145A-C, the BRAS 150 and/or the LAC 155 to provide data and/or communication services across any type(s) and/or size(s) of geographic area(s). Persons of ordinary skill in the art will readily recognize that any of the access network 102, the access multiplexers 105A-C, the backhaul network 140, the communication paths 145A-C, the BRAS 150 and/or the LAC 155 may be owned and/or operated by a different service provider. For example, a first service provider may own and/or operate the backhaul network 140, while a second service provider owns and/or operates one or more of the access multiplexers 105A-C, the BRAS 150 and/or the LAC 155.

Because in communication systems like the example communication system illustrated in FIG. 1, the communication paths 145A-C typically have symmetric data rates (e.g., same data rate in both directions) while the user devices 110A-H are coupled to the access network 102 via asymmetric data rates (e.g., receiving data at a higher data rate than they transmit data), the example bandwidth managers 160 and 161 of FIG. 1 control the allocation and/or utilization of bandwidth in the direction from the BRAS 150 and/or the LAC 155 towards the user devices 110A-H. However, the BRAS 150 and/or the LAC 155 could likewise implement bandwidth management for controlling the allocation of bandwidth in the direction from the user devices 110A-H to the BRAS 150 and/or the LAC 155 using methods and/or apparatus similar to those described herein.

While this disclosure refers to the example user devices 110A-H of FIG. 1, the example communication system of FIG. 1 may be used to provide services to, from and/or between any alternative and/or additional wired and/or wireless communication devices (e.g., telephone devices, personal digital assistants (PDA), laptops, etc.). Additionally, although for purposes of explanation, the descriptions contained herein refer to the example communication system, the example access network 102, the example access multiplexers 105A-C, the example backhaul network 140, the example communication paths 145A-C, the example BRAS 150 and/or the example LAC 155 of FIG. 1, any additional and/or alternative type(s) and/or number of communication systems, communication devices and/or communication paths than those illustrated in FIG. 1 may be used to implement the communication system and/or to provide data and/or communication services.

FIG. 2 illustrates an example manner of implementing any and/or all of the example bandwidth managers 160 and 161 of FIG. 1. While any and/or all of the example bandwidth managers 160 and 161 of FIG. 1 may be represented by FIG. 2, for ease of discussion, the example device of FIG. 2 will be referred to as bandwidth manager 160. To monitor the utilization and/or loading of a backhaul transmission link (e.g., any of the example communication paths 145A-C of FIG. 1), the example bandwidth manager 160 of FIG. 2 includes a bandwidth monitor 205. Using any number of algorithm(s), method(s), logic, measurement(s) and/or circuits, the example bandwidth monitor 205 periodically and/or aperiodically determines the current loading of each backhaul transmission link and/or segment(s) of each backhaul transmission link managed by the bandwidth manager 160.

To control the allocation of bandwidth to user devices 110A-H, the example bandwidth manager 160 of FIG. 2 includes a bandwidth controller 210. The example bandwidth controller 210 of FIG. 2 obtains and/or receives a utilization value for a communication path 145A-C and/or segment of a communication path 145A-C from the example bandwidth monitor 205, and decides whether to change bandwidth profiles for user devices of the communication path 145A-C based on the utilization value.

When the utilization of a particular communication path 145A-C and/or segment(s) of the particular communication path 145A-C exceed a first threshold (e.g., 80% or 90% utilization), the example bandwidth controller 210 of FIG. 2 instructs a profile selector 215 to select a lower data rate bandwidth profile for each user device of the communication path 145A-C. Likewise, when the utilization falls below a second threshold (e.g., 50% or 60% utilization), the bandwidth controller 210 instructs the profile selector 215 to select a higher data rate bandwidth profile for each user device of the communication path 145A-C. Once bandwidth profiles have been selected, the example bandwidth controller 210 of FIG. 2 instructs a bandwidth enforcer 235 to set and/or enforce the bandwidth profile for each user device of the communication path 145A-C.

In the illustrated example of FIG. 2, as the loading of a communication path 145A-C changes, all user devices of the communication path 145A-C have their corresponding bandwidth profile adjusted. For example, as the loading increases, all users devices of the communication path 145A-C are changed to a lower data rate bandwidth profile, thereby, ensuring fair and/or equitable access to the bandwidth of the corresponding communication path 145A-C.

To select bandwidth profiles for user devices of a communication path 145A-C, the example bandwidth manager 160 of FIG. 2 includes the profile selector 215. The example profile selector 215 of FIG. 2 uses a set of bandwidth profiles 225 and customer records 220 to select a profile for each user device of the affected communication path 145A-C. For example, when the profile selector 215 is to select a lower bandwidth profile, the profile selector 215 queries the customer records 225 to determine the current bandwidth profile and to determine the minimum bandwidth profile available under the corresponding service contract. The profile selector 215 then selects the next lower bandwidth profile for the set of bandwidth profiles 220 that is not less than the minimum bandwidth profile.

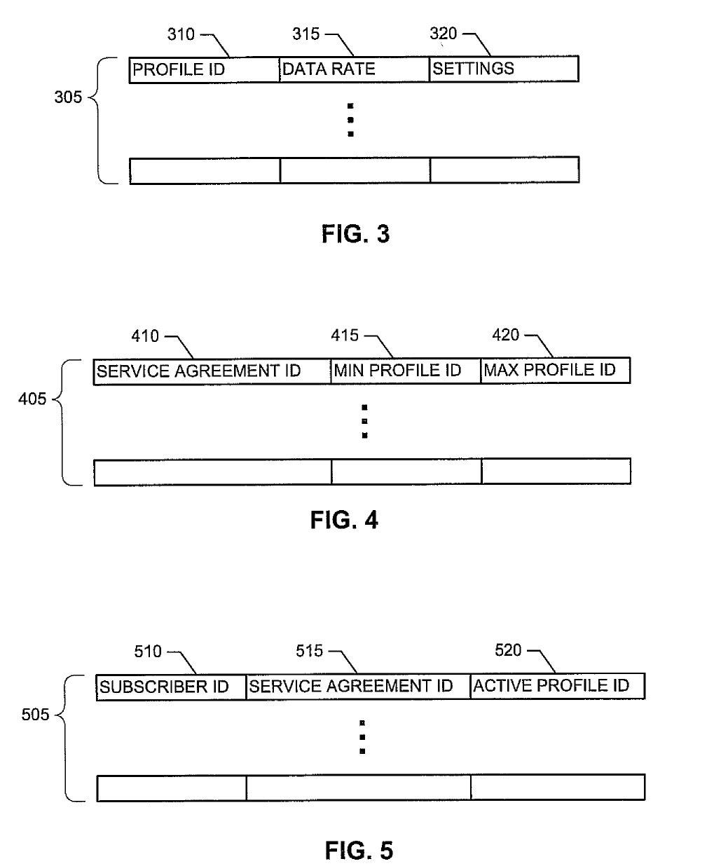

To store the example bandwidth profiles 220 and the example customer records 220, the example bandwidth manager 160 of FIG. 2 includes any number and/or type(s) of machine accessible memories 230. An example data structure that may be used to implement the example profiles 220 of FIG. 2 is described below in connection with FIG. 3. Example data structures that may be used to implement the example customer records 225 of FIG. 2 are described below in connection with FIGS. 4 and 5.

To set and/or enforce bandwidth profiles, the example bandwidth manager 160 of FIG. 2 includes the bandwidth enforcer 235. Based on a bandwidth profile set by the example bandwidth controller 210 and using any number of algorithm(s), method(s), logic, measurement(s) and/or circuits, the example bandwidth enforcer 235 of FIG. 2 ensures that a user device 110A-H associated with the bandwidth profile does not exceed the specified data rate. For example, the bandwidth enforcer 235 may track the continuous and/or peak data rate used by the user device 110A-H. When and/or if the user device 110A-H exceeds its allocated data rate, the bandwidth enforcer 235 queues the user device's data until the continuous and/or peak data rate falls below its allocated data rate. By queuing a user device's data, the example bandwidth enforcer 235 causes a temporary increase in round-trip transmission time between the user device 110A-H and the service network 120, thereby, causing the service network 120 and/or the user device 110A-H to react to the increased round-trip transmission time by transmitting data at a lower data rate.

While an example manner of implementing any of the example bandwidth managers 160 and 161 of FIG. 1 is illustrated in FIG. 2, the bandwidth managers 160 and 161 of FIG. 1 may be implemented using any number and/or type(s) of alternative and/or additional processors, devices, components, circuits, modules, interfaces, etc. Further, the processors, devices, components, circuits, modules, elements, interfaces, etc. illustrated in FIG. 2 may be combined, re-arranged, eliminated and/or implemented in any other way. Additionally, the bandwidth monitor 205, the example bandwidth controller 210, the example profile selector 215, the example bandwidth enforcer 235 and/or, more generally, the example bandwidth managers 160 and 161 may be implemented as any combination of firmware, software, logic and/or hardware. Moreover, the example bandwidth managers 160 and 161 may include additional processors, devices, components, circuits, interfaces and/or modules than those illustrated in FIG. 2 and/or may include more than one of any or all of the illustrated processors, devices, components, circuits, interfaces and/or modules.

FIG. 3 illustrates an example data structure that may be used to implement the example bandwidth profiles 220 of FIG. 2. The example data structure of FIG. 3 includes a plurality of entries 305 for respective ones of a plurality of bandwidth profiles.

To identify a bandwidth profile, each of the example entries 305 of FIG. 3 includes a profile identification (ID) field 310. The example profile ID field 310 of FIG. 3 contains a numeric value that uniquely identifies the bandwidth profile.

To specify a data rate, each of the example entries 305 of FIG. 3 includes a data rate field 315. The example data rate field 315 of FIG. 3 contains a numeric value that represents the data rate associated with the bandwidth profile.

To specify one or more settings, each of the example entries 305 of FIG. 3 includes a settings field 320. The example settings field 315 of FIG. 3 contains one or more values and/or alphanumeric strings that represent one or more additional settings associated with the bandwidth profile such as a quality of service (QoS) parameter, a user name, an authentication credential, etc. Such settings may be used by a BRAS (e.g., the example BRAS 150 of FIG. 1) and/or a LAC (e.g., the example LAC 155) to control, configure and/or enforce a bandwidth profile.

FIGS. 4 and 5 illustrate example data structures that may be used to implement the example customer records 225 of FIG. 2. The example data structure of FIG. 4 includes a plurality of entries 405 for respective ones of a plurality of service agreements.

To identify a service agreement, each of the example entries 405 of FIG. 4 includes a service agreement ID field 410. The example service agreement ID field 410 of FIG. 4 contains a numeric value that uniquely identifies the service agreement.

To specify a minimum data rate, each of the example entries 405 of FIG. 4 includes a minimum profile ID field 415. The example minimum profile ID field 415 of FIG. 4 contains a numeric value (e.g., a pointer) that represents the minimum bandwidth profile that satisfies the service agreement. The example minimum profile ID field 415 of FIG. 4 contains a pointer to one of the example profile ID fields 310 of FIG. 3.

To specify a maximum data rate, each of the example entries 405 of FIG. 4 includes a maximum profile ID field 420. The example maximum profile ID field 420 of FIG. 4 contains a numeric value (e.g., a pointer) that represents the maximum bandwidth profile that satisfies the service agreement. The example maximum profile ID field 420 of FIG. 4 contains a pointer to one of the example profile ID fields 310 of FIG. 3.

The example data structure of FIG. 5 includes a plurality of entries 505 for respective ones of a plurality of user devices 110A-H. To identify a user device 110A-H, each of the example entries 505 of FIG. 5 includes a subscriber ID field 510. The example subscriber ID field 510 of FIG. 5 contains a numeric value and/or alphanumeric string that uniquely identifies the user device 110A-H.

To specify a service agreement, each of the example entries 505 of FIG. 5 includes a service agreement ID field 515. The example service agreement field 515 of FIG. 5 contains a numeric value (e.g., a pointer) that represents a service agreement. The example service agreement ID field 515 of FIG. 5 contains a pointer to one of the example service agreement ID fields 410 of FIG. 4.

To specify a current bandwidth profile, each of the example entries 505 of FIG. 5 includes an active profile ID field 520. The example active profile ID field 520 of FIG. 5 contains a numeric value (e.g., a pointer) that represents a bandwidth profile. The example active profile ID field 520 of FIG. 5 contains a pointer to one of the example profile ID fields 310 of FIG. 3. The active profile ID field 520 may contain a pointer to the minimum profile, to the maximum profile and/or to a profile intermediate the maximum and minimum profiles.

To use the example data structures of FIGS. 3, 4 and 5, a bandwidth manager 160, 161 identifies a user device 110A-H currently using a communication path 145A-C of interest. The example profile selector 215 of FIG. 2 locates an entry 505 of the example data structure of FIG. 5 corresponding to the identified user device 110A-D to identify the service agreement 515 and the current (e.g., active) bandwidth profile 520 for the user device 110A-D. Using the example data structure of FIG. 4, the profile selector can lookup the minimum and maximum bandwidth profiles 415 and 420 based on the user device's service agreement 515. Based on the current bandwidth profile 520, the minimum and the maximum bandwidth profiles 415 and 420 and as instructed by a bandwidth controller (e.g., the example bandwidth controller 210), the profile selector can select a higher and/or lower data rate bandwidth profile for the user device 110A-D.

While example data structures are illustrated in FIGS. 3, 4 and 5, the example data structures may be implemented using any number and/or type(s) of other and/or additional fields and/or data. Further, the fields and/or data illustrated in FIGS. 3-5 may be combined, divided, re-arranged, eliminated and/or implemented in any of a number of ways. Moreover, the example data structures may include additional fields and/or data than those illustrated in FIGS. 3-5 and/or may include more than one of any or all of the illustrated fields and/or data.

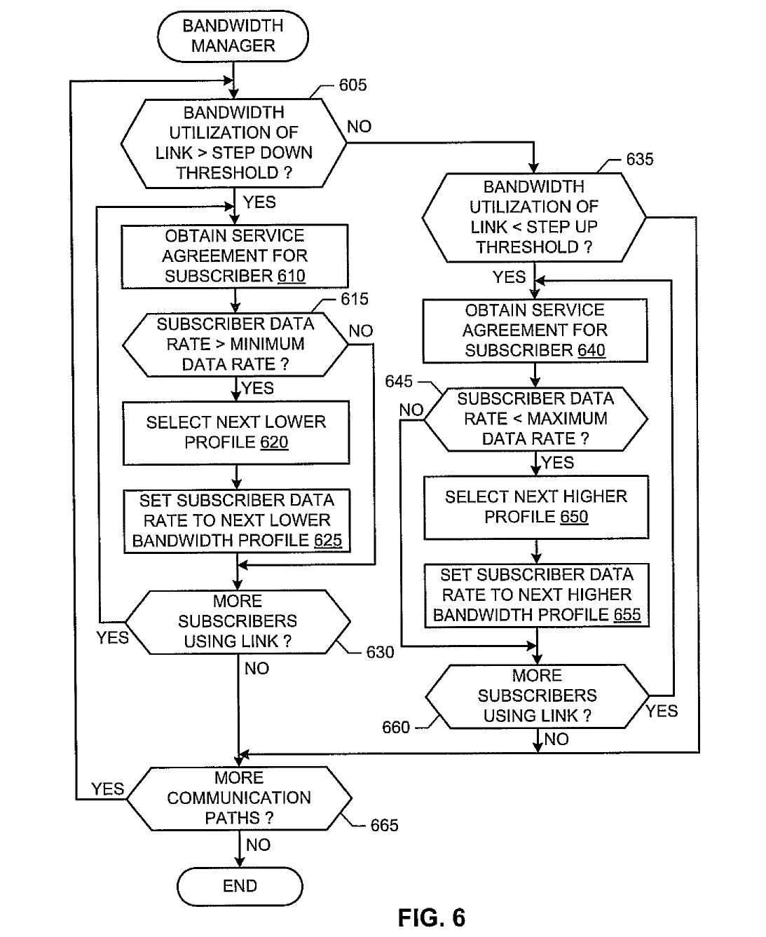

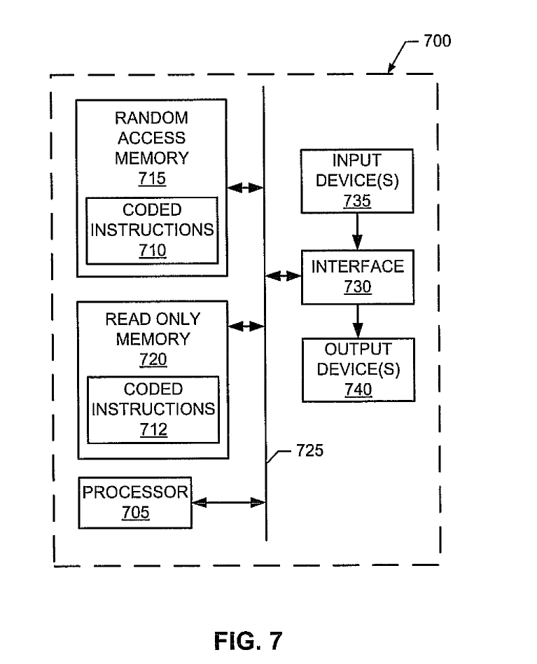

FIG. 6 is a flowchart representative of example machine accessible instructions that may be executed to implement any and/or all of the example bandwidth managers 160 and 161 of FIGS. 1 and 2. The example machine accessible instructions of FIG. 6 may be executed by a processor, a controller and/or any other suitable processing device. For example, the example machine accessible instructions of FIG. 6 may be embodied in coded instructions stored on a tangible medium such as a flash memory, a read-only memory (ROM) and/or random-access memory (RAM) associated with a processor (e.g., the example processor 705 discussed below in connection with FIG. 7). Alternatively, some or all of the example flowchart of FIG. 6 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example flowchart of FIG. 6 may be implemented manually or as any combination(s) of any of the foregoing techniques. For example, either of the bandwidth managers 160, 161 and/or any or all of the blocks of FIG. 2 may be implemented by any combination of firmware, software, discrete logic and/or hardware. Further, although the example machine accessible instructions of FIG. 6 are described with reference to the flowchart of FIG. 6, persons of ordinary skill in the art will readily appreciate that many other methods of implementing the example bandwidth managers described herein may be employed. For example, the order of execution of the blocks may be changed, and/or some of the blocks described may be changed, eliminated, sub-divided, or combined. Additionally, persons of ordinary skill in the art will appreciate that the example machine accessible instructions of FIG. 6 may be carried out sequentially and/or carried out in parallel by, for example, separate processing threads, processors, devices, discrete logic, circuits, etc.

The example machine accessible instructions of FIG. 6 begin when a bandwidth manager (e.g., any of the example bandwidth managers 160, 161 of FIGS. 1 and 2) receives, obtains and/or develops new and/or updated communication utilization values for one or more communication paths (e.g., one or more of the example communication paths 145A-C). If the bandwidth utilization of a presently considered communication path exceeds a step down threshold (e.g., 80% or 90% utilization) (block 605), the bandwidth manager (e.g., the example profile selector 215 of FIG. 2) looks up the service agreement and current bandwidth profile for a first user device of the presently considered communication path (block 610).

If the user device's current bandwidth profile is at least one bandwidth profile above the minimum bandwidth profile for the service agreement (block 615), the profile selector selects the next lower bandwidth profile for that user (block 620). The bandwidth manager (e.g., the bandwidth controller 210 of FIG. 2) instructs a bandwidth enforcer (e.g., the example bandwidth enforcer 235) to set and start enforcing the new bandwidth profile for the user device (block 625). If there are more user devices employing the presently consider communication path (block 630), control returns to block 610 to process the next user device.

If there are no more user devices presently using the communication path at issue (block 630), the bandwidth manager determines if there are new and/or updated utilization values for one or more additional communication paths (block 665). If there are new and/or updated utilization values for one or more additional communication paths (block 665), control returns to block 605 to process the next communication path. If there are no more new and/or updated utilization values for any communication paths (block 665), control exits from the example machine accessible instructions of FIG. 6.

Returning to block 615, if the user device's current bandwidth profile is not at least one bandwidth profile above the minimum bandwidth profile for the service agreement (block 615), control proceeds to block 630 without selecting and/or setting a new bandwidth profile for the user device.

Returning to block 605, if the bandwidth utilization of a presently considered communication path is less than a step down threshold (block 605), the bandwidth manager determines whether the bandwidth utilization is less than a step up threshold (e.g., 50% of 60% utilization) (block 635). If the bandwidth utilization is not less than the step up threshold (block 635), control proceeds to block 665 to determine if there are more new and/or updated utilization values for any communication paths to consider.

If the bandwidth utilization is less than the step up threshold (block 635), the bandwidth manager (e.g., the example profile selector 215 of FIG. 2) looks up the service agreement and current bandwidth profile for a first user device of the presently considered communication path (block 640).

If the first user device's current bandwidth profile is at least one bandwidth profile below the maximum bandwidth profile for the service agreement (block 645), the profile selector selects the next higher bandwidth profile for that user (block 650). The bandwidth manager (e.g., the bandwidth controller 210 of FIG. 2) instructs a bandwidth enforcer (e.g., the example bandwidth enforcer 235) to set and start enforcing the new bandwidth profile for the corresponding user device (block 655). If there are more user devices utilizing the communication path under consideration (block 660), control returns to block 640 to process the next user device.

If there are no more user devices of the presently considered communication path to be processed (block 660), control proceeds to block 665 to determine if there are new and/or updated utilization values to be considered for any communication path(s).

Returning to block 645, if the user device's current bandwidth profile is not at least one bandwidth profile below the maximum bandwidth profile for the service agreement (block 645), control proceeds to block 660 without selecting and/or setting a new bandwidth profile for the user device.

FIG. 7 is a schematic diagram of an example processor platform 700 that may be used and/or programmed to implement all or a portion of any of the example bandwidth managers 160 and 161 of FIGS. 1 and 2. For example, the processor platform 700 can be implemented by one or more general purpose processors, processor cores, microcontrollers, etc.

The processor platform 700 of the example of FIG. 7 includes at least one general purpose programmable processor 705. The processor 705 executes coded instructions 710 and/or 712 present in main memory of the processor 705 (e.g., within a RAM 715 and/or a ROM 720). The processor 705 may be any type of processing unit, such as a processor core, a processor and/or a microcontroller. The processor 705 may execute, among other things, the example machine accessible instructions of FIG. 6. The processor 705 is in communication with the main memory (including a ROM 720 and/or the RAM 715) via a bus 725. The RAM 715 may be implemented by dynamic RAM (DRAM), synchronous DRAM (SDRAM), and/or any other type of RAM device, and ROM may be implemented by flash memory and/or any other desired type of memory device. Access to the memory 715 and 720 maybe controlled by a memory controller (not shown). The RAM 715 may be used to store and/or implement, for example, the example bandwidth profiles 220 and/or the example customer records 225 of FIG. 2.

The processor platform 700 also includes an interface circuit 730. The interface circuit 730 may be implemented by any type of interface standard, such as an external memory interface, serial port, general purpose input/output, etc. One or more input devices 735 and one or more output devices 740 are connected to the interface circuit 730. The input devices 735 and/or output devices 740 may be used to, for example, monitor backhaul transmission link utilization and/or to enforce a bandwidth profile.

Of course, persons of ordinary skill in the art will recognize that the order, size, and proportions of the memory illustrated in the example systems may vary. Additionally, although this patent discloses example systems including, among other components, software or firmware executed on hardware, it will be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, persons of ordinary skill in the art will readily appreciate that the above described examples are not the only way to implement such systems.

At least some of the above described example methods and/or apparatus are implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of the invention are not limited to such devices, standards and/or protocols. Such systems are periodically superseded by faster or more efficient systems having the same general purpose. Accordingly, replacement devices, standards and/or protocols having the same general functions are equivalents which are intended to be included within the scope of the accompanying claims.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. An apparatus comprising:
an access multiplexer communicatively coupled to a services network via a communication path, and configured to communicate with a first user device via a first connection and with a second user device via a second connection; and
a bandwidth manager to set a first bandwidth profile for the first connection and a second bandwidth profile for the second connection based on a utilization of the communication path.

2. An apparatus as defined in claim 1, further comprising a broadband remote access server (BRAS), wherein the communication path is a backhaul communication link between the access multiplexer and the BRAS and the bandwidth manager is located in the BRAS.

3. (canceled)

4. An apparatus as defined in claim 1, further comprising a broadband remote access server (BRAS), wherein the first and the second bandwidth profiles are enforced at the BRAS.

5. An apparatus as defined in claim 4, wherein, under a first condition, the first bandwidth profile is enforced for the first connection without the first connection being reinitialized.

6. An apparatus as defined in claim 1, wherein the access multiplexer is a digital subscriber line (DSL) access multiplexer (DSLAM), and the first and second user devices are DSL modems.

7. (canceled)

8. (canceled)

9. An apparatus as defined in claim 1, wherein the wireless base station is implemented in accordance with Institute of Electrical and Electronics Engineers (IEEE) 802.16 standard.

10. An apparatus as defined in claim 1, wherein the communication path is an asynchronous transfer mode (ATM) based communication path.

11. An apparatus as defined in claim 1, wherein the communication path is an Internet Protocol (IP) based communication path.

12. An apparatus as defined in claim 1, wherein the utilization of the communication path is a percentage of the transmission capacity of the communication path.

13. An apparatus as defined in claim 1, wherein the bandwidth manager comprises:
a database to store a set of bandwidth profiles; and
a profile selector to select the first and the second bandwidth profiles from the set of bandwidth profiles.

14. An apparatus as defined in claim 13, wherein the bandwidth manager further comprises:
a bandwidth monitor to measure a utilization of the communication path; and
a bandwidth controller to set the first bandwidth profile for the first connection and the second bandwidth profile for the second connection based on the utilization of the communication path.

15. An apparatus as defined in claim 14, wherein setting the first bandwidth profile for the first connection lowers a first transmission speed for the first connection.

16. An apparatus as defined in claim 14, wherein the profile selector is to select a third bandwidth profile for the first connection and a fourth bandwidth profile for the second connection when the utilization of the communication path is less than a threshold, wherein the third bandwidth profile configures the first connection for a higher transmission speed than the first bandwidth profile.

17. A method of configuring an access network, the method comprising:
measuring a utilization of a communication path between an access multiplexer and a broadband remote access server (BRAS), the communication path transporting data for one or more connections between the access multiplexer and respective ones of one or more user devices; and
setting a bandwidth profile for a first one of the one or more connections based on the measured utilization of the communication path.

18. A method as defined in claim 17, further comprising enforcing the bandwidth profile at the BRAS.

19. (canceled)

20. (canceled)

21. (canceled)

22. (canceled)

23. (canceled)

24. A method as defined in claim 17, wherein the utilization of the communication path is a percentage of the transmission capacity of the communication path.

25. A method as defined in claim 17, further comprising setting a second bandwidth profile for a second one of the one or more connections based on the measured utilization.

26. A method as defined in claim 17, wherein enforcing the bandwidth profile affects all services transported via the first one of the one or more connections.

27. A method as defined in claim 17, further comprising selecting the bandwidth profiles from a set of bandwidth profiles.

28. A method as defined in claim 27, wherein the set of bandwidth profiles conform to a service agreement associated with the first one of the one or more connections.

29. A method as defined in claim 17, further comprising selecting the first bandwidth profile to set a lower transmission speed for the first one of the one or more connections when the utilization of the communication path is greater than a threshold.

30. A method as defined in claim 29, further comprising selecting a second bandwidth profile to set a lower transmission speed for the first one of the one or more connections when the utilization of the communication path is less than a threshold.

31. An article of manufacture storing machine accessible instructions which, when executed, cause a machine to:
measure a utilization of a communication path between an access multiplexer and a broadband remote access server (BRAS), the communication path transporting data for one or more connections between the access multiplexer and respective ones of one or more user devices; and
set a bandwidth profile for a first one of the one or more connections based on the measured utilization of the communication path.

32. An article of manufacture as defined in claim 31, wherein the machine accessible instructions, when executed, cause the machine to enforce the bandwidth profile at the BRAS.

33. An article of manufacture as defined in claim 31, wherein the utilization of the communication path is a percentage of the transmission capacity of the communication path.

34. An article of manufacture as defined in claim 31, wherein the machine accessible instructions, when executed, cause the machine to set a second bandwidth profile for a second one of the one or more connections based on the measured utilization.

35. (canceled)

36. An article of manufacture as defined in claim 31, wherein the machine accessible instructions, when executed, cause the machine to select the bandwidth profiles from a set of bandwidth profiles.

37. An article of manufacture as defined in claim 36, wherein the set of bandwidth profiles conform to a service agreement associated with the first one of the one or more connections.

38. An article of manufacture as defined in claim 31, wherein the machine accessible instructions, when executed, cause the machine to select the first bandwidth profile to set a lower transmission speed for the first one of the one or more connections when the utilization of the communication path is greater than a threshold.

39. An article of manufacture as defined in claim 38, wherein the machine accessible instructions, when executed, cause the machine to select a second bandwidth profile to set a lower transmission speed for the first one of the one or more connections when the utilization of the communication path is less than a threshold.
